(19) United States
(12) Patent Application Publication
(10) Pub. No.: US 2018/0144368 A1
(43) Pub. Date: May 24, 2018

(54) ISOLATING ADVERTISING IDENTIFIERS FROM APPLICATIONS

(71) Applicant: GOOGLE INC., Mountain View, CA (US)

(72) Inventors: Marijn Kruisselbrink, Oakland, CA (US); Renaud Jean Ghislain Paquay, Redwood City, CA (US); Sriram Saroop, Mountain View, CA (US); Erik Kay, Belmont, CA (US)

(73) Assignee: GOOGLE INC., Mountain View, CA (US)

(21) Appl. No.: 13/975,908

(22) Filed: Aug. 26, 2013

(51) Int. Cl. G06Q 30/02

(52) U.S. Cl. CPC G06Q 30/0257

(57) ABSTRACT

A system and method include exposing, via an application programming interface, an advertising identifier to an online advertising network executing by at least one microprocessor of a computing device. The advertising identifier is associated with a user profile and is associated with a set of packaged web applications associated with the user profile. The system automatically restricts the set of packaged web applications from accessing the advertising identifier by sandboxing a process within each of the set of packaged web applications that utilizes the advertising identifier.

### TECHNICAL FIELD

This description generally relates to advertising via web applications.

### BACKGROUND

A cloud server that provides advertising may use a stable, unique identifier to provide targeted advertising and to optimize advertising to the same user across various software applications such as packaged web applications. The identifier may be shared across the applications. Yet, users may not wish to allow each application access to the identifier, for example for anonymity or privacy reasons. Accordingly, there exists a need for systems and methods to address the shortfalls of present technology and to provide other new and innovative features.

### SUMMARY

A system and method provide a model for allowing an advertising network to prevent an advertising identifier from being visible to a packaged web application showing advertisements (ads). The advertising identifier is visible only to the trusted advertising network. The system may sandbox the network code running in the application and expose the identifier only to the advertising network. The system may use an adview tag element to allow the application writer to specify an ad network. The identifier may be unique for both each user profile and unique for the same, single advertising network across all apps.

According to one implementation, a method includes exposing, via an application programming interface, an advertising identifier to an online advertising network executing by at least one microprocessor of a computing device. The advertising identifier may be associated with a user profile and is associated with a set of packaged web applications associated with the user profile. The method includes automatically restricting the set of packaged web applications from accessing the advertising identifier by sandboxing a process within each of the set of packaged web applications that utilizes the advertising identifier. Other implementations of this aspect include corresponding system, apparatus, and computer programs, configured to perform the actions of the methods, encoded on computer storage devices.

According to another implementation, a method includes projecting, using a microprocessor of a computing device, advertisements via an online advertising network, including: selecting an advertising URL from the online advertising network, using a unique advertising identifier associated with a user account; projecting an element of the advertising URL into an advertising view of a web application associated with the user account; and restricting the web application from accessing a document object model subtree of the advertising view. Other implementations of this aspect include corresponding system, apparatus, and computer programs, configured to perform the actions of the methods, encoded on computer storage devices.

According to yet another implementation, a system includes means for exposing an advertising identifier to an online advertising network, wherein the advertising identifier is associated with a user profile and is associated with a packaged web application associated with the user profile. The system includes means for automatically restricting the packaged web application from accessing the advertising identifier by sandboxing a process within the packaged web application that utilizes the advertising identifier.

Advantages of the systems and methods described here include increased security by providing a stable advertising identifier that is unique to a user and unique to an advertising network, and that is visible only to the advertising network. Advantages include preventing accidental exposure of the advertising identifier to web applications, as well as preventing malicious web applications from accessing the advertising identifier.

The details of one or more implementations are set forth in the accompanying drawings and the description below. Other features will be apparent from the description and drawings, and from the claims.

### BRIEF DESCRIPTION OF THE DRAWINGS

FIG. 1 is an example block diagram of a web application framework.

FIG. 2 is an example block diagram of a multi-process model framework.

FIG. 3A is an example of a user interface for a web application.

FIG. 3B is an example of another user interface for a web application.

FIG. 4 illustrates examples of code for the application programming interface (API) that may be used by a web application.

FIG. 5 is a block diagram of a system that may be used to implement the techniques described here.

FIG. 6 is a flow diagram illustrating example operations of the system of FIGS. 1-5.

FIG. 7 is another flow diagram illustrating example operations of the system of FIGS. 1-5.

FIG. 8 is a block diagram showing example or representative computing devices and associated elements that may be used to implement systems and methods in accordance with FIGS. 1-7.

Like reference symbols in the various drawings indicate like elements.

### DETAILED DESCRIPTION

A document object model (DOM) is a cross-platform and language-independent convention for representing and interacting with objects in HTML, XHTML, and XML documents. As used herein, a “document” refers to the DOM's underlying document. A “node” refers to any DOM object that participates in a tree. A DOM “tree” refers to any tree composed of DOM objects. Objects in a DOM tree may be addressed and manipulated by using methods on the objects. A “DOM structure” refers to a DOM tree or fragment of a DOM tree.

Web applications may follow a model-view-controller (MVC) design pattern for user interfaces that divides an application into three areas of responsibility: (a) the Model: the domain objects or data structures that represent the application's state; (b) the View, which observes the state and generates output to the users; and (c) the Controller, which translates user input into operations on the model.

Using implementations of a “shadow DOM”, it is possible to provide better separation of concerns between the View and Model primitive data types. With shadow DOM, an HTML document consists of a list of Models, and each Model is a child of the document's body. A shadow DOM subtree is created on the body of the document. This subtree represents the View. In this subtree, one or more insertion points are used as openings in the View, through which the Model bits show through, and matching criteria of the insertion points are used by the Controller to specify which Model to show in a View. The matching criteria may be represented by a “select” attribute on a <content> HTML element.

When the Controller (e.g., web application) modifies this attribute value, the matching criteria changes, which in turn triggers a change of what is being rendered in place of this <content> HTML element. A developer of a web application can designate DOM elements in the document as Views and change the matching criteria to match any of these DOM elements to make them appear in place of the <content> HTML element, thereby providing a clean separation between the content of the View and how its selection is controlled. The Model bits are never changed or informed in any way by the Controller (or View), even while the View is changed. Thus, user interfaces of web applications, and components of the user interfaces, may be manipulated, modified, and enhanced, without requiring changes to the basic code of the document markup of the web application Model.

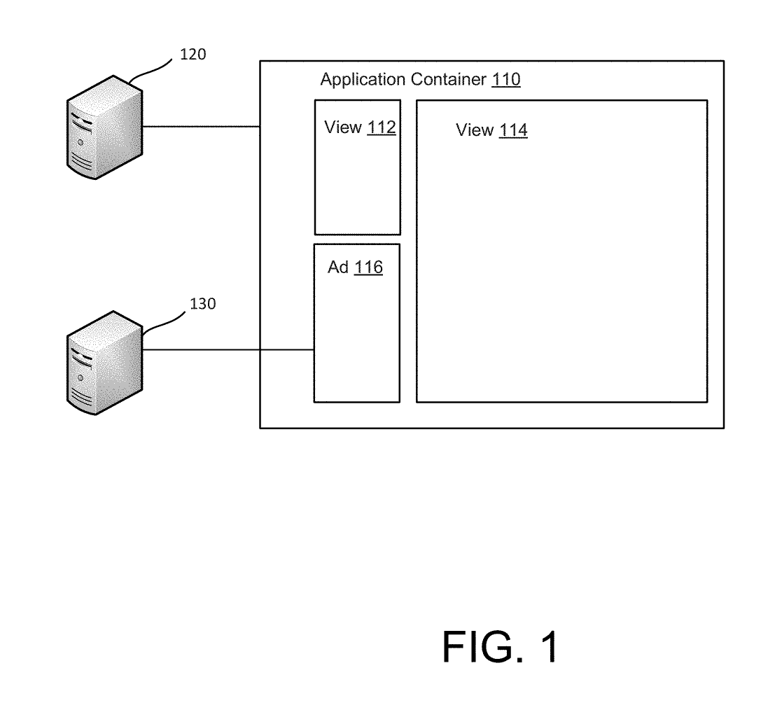

FIG. 1 is an example block diagram of a web application framework. In this context, a “web application” may be configured to execute a single task or multiple tasks for a user. In such an implementation, the web application may be configured to be executed or interpreted by a web browser. This is compared with the native applications that include machine executable code and are configured to be executed directly by a processor or via the operating system of the client device, whereas, a web application may be incapable of execution or display without the aid of the web browser. Thus, web applications can be run inside a browser with a dedicated user interface, and typically provide functionality and an experience that is more rich and interactive than a standalone website but are less cumbersome and monolithic than a desktop application. Examples of web applications include games, photo editors, and video players that are run inside the browser.

Web application developers often encounter the need to provide encapsulation of a DOM structure. A web application user interface may be composed of several user interface elements (or “widgets”), each representing a DOM subtree.

As shown in the implementation depicted in FIG. 1, an example application container 110 may include a “view” widget 112, a “view” widget 114, and an “ad” widget 116. The application container may communicate with a server 120. The server 120 may be a collection of one or more computers or networks that may serve content for the web application, such as view 112 and view 114. An ad element 116, contained in the application container 110, may communicate with a server 130. The server 130 may be a collection of one or more computers or networks that may serve advertising for the ad element 116. In some examples, the server 130 may represent a central server of an advertising network. An advertising network, as described here, is an aggregation of online advertising using at least one central server to deliver advertisements to consumers. In some cases, an advertising network may using targeting, tracking, and reporting of impressions. An advertiser that participates in an advertising network may wish to optimize advertisements to the same user across various different web applications.

In cases where a widget is tasked with hosting other widgets, the widget may need to understand where its DOM subtree ends and another widget's DOM subtree begins. A “shadow DOM” structure allows multiple shadow DOM subtrees (in addition to the document tree) to be composed into one larger tree when rendered (for example, by a renderer process of a browser). The existence of multiple shadow DOM subtrees is enabled by letting any element in the document tree host one or more additional DOM subtrees.

When rendered, for example by a renderer of a web browser, the shadow DOM subtree may take the place of the shadow host's content. Thus, when rendered, the document tree may include the content form one or more shadow DOM subtrees, thus allowing a web application to expose parts of a view and switch to expose other parts of a web page. This allows a developer of the web application to avoid re-coding up a whole web application or web page and avoid the complexity of managing the web page using the MVC design pattern.

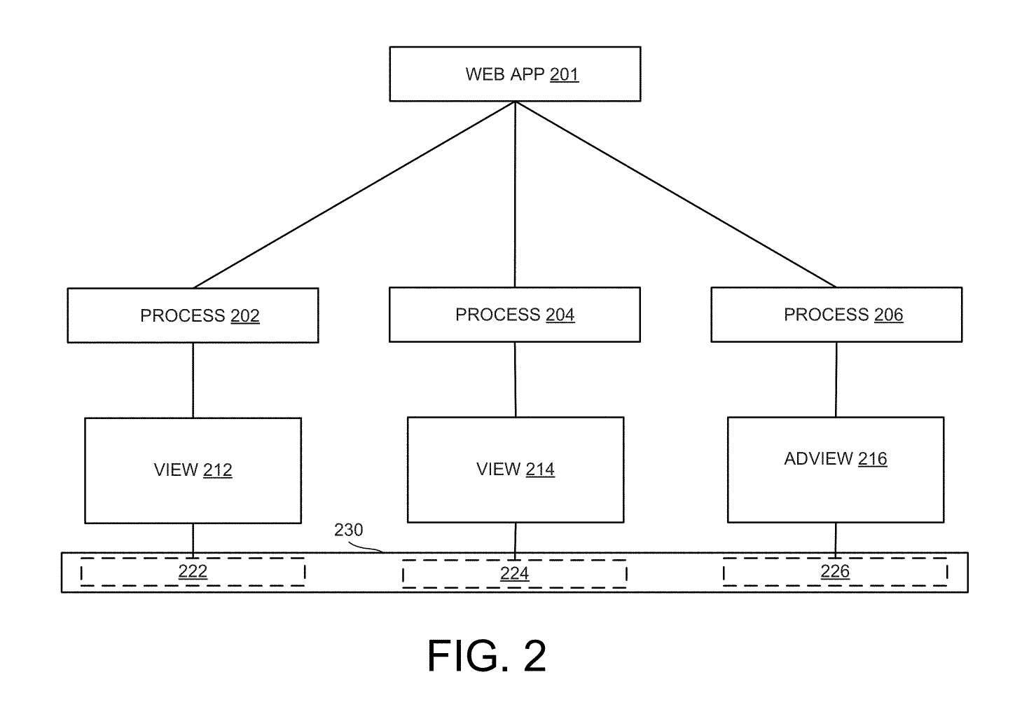

A web browser that implements the web application described in FIG. 1 may, in some implementations, operate using a multi-process architecture, as described in more detail below with respect to FIG. 2.

FIG. 2 is an example block diagram of a multi-process model framework. As shown in FIG. 2, a single web app 201 may operate using multiple processes, such as a process 202, a process 204, and a process 206. Each process may be run in a sandbox, which means it has its own access to separate, isolated portions of storage of a computing device. Sandboxing leverages the operating system-provided security to allow code execution that may not make persistent changes to a computer or access information that is confidential. The architecture that the sandbox provides may be dependent on the computer's operating system.

In the example shown in FIG. 2, a view 212 running in the process 202 may access isolation storage 222 of a computer's memory 230. The view 214 running in the process 204 may access isolation storage 224 of a computer's memory 230. The adview 216 running in the process 206 may access isolation storage 226 of a computer's memory 230.

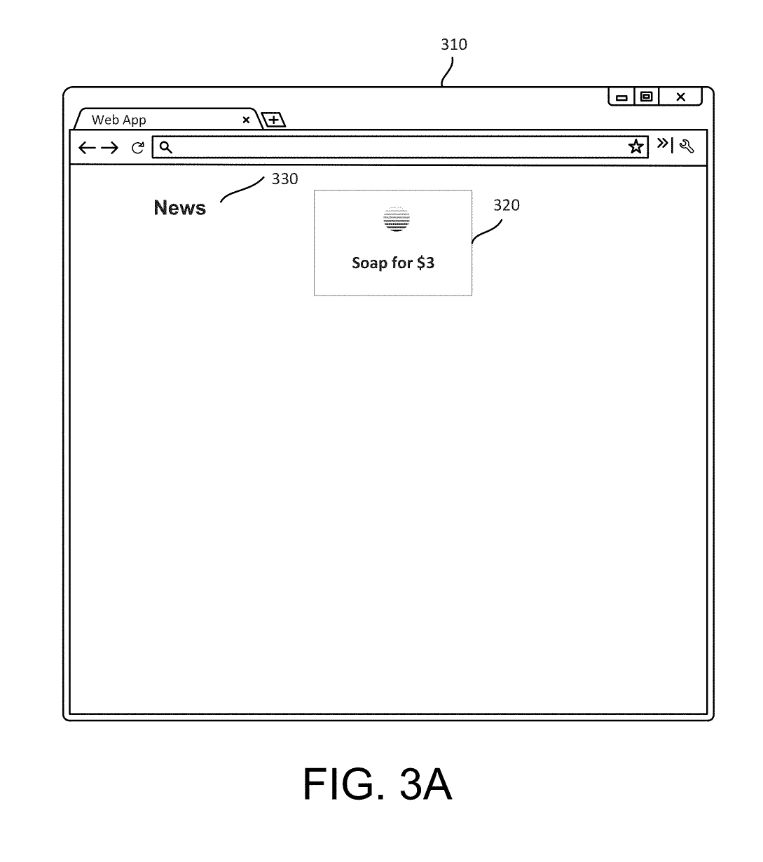

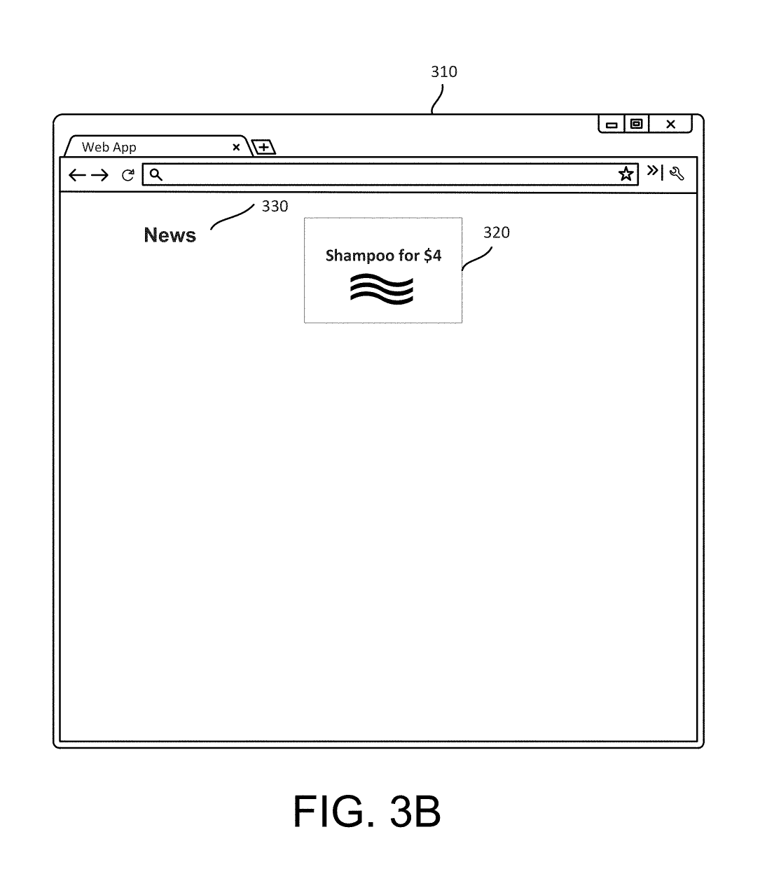

FIG. 3A is an example of a user interface for a web application, in accordance with techniques described here. User interface 310 may be a user interface for a portion of a web application (e.g., a web page displayed in a web browser), as described above with respect to FIGS. 1-2. User interface 310 may include various content elements, such as text element 330, which may include text such as “News”. User interface 310 may also include an adview element 320, which may include advertising content pulled from a URL associated with a whitelisted advertising network or data store such as data store 130 described above with respect to FIG. 1. The advertising content may be pulled from a URL, and may include text such as “Soap for $3”, as shown. The adview element 320 may be any size such as full screen, and may contain any combination of text, images, video, audio, animation, or other content.

As described above with respect to FIGS. 1-2, when the controller, in this case a web application, modifies an attribute value for the adview element, the matching criteria changes, which in turn triggers a change of what is being rendered in place of the adview element 320.

The web application and the adview element 320 may exchange messages, for example using a wsindows.postMessage method, but the web application cannot access the advertising identifier.

FIG. 3B is another example of a user interface for a web application, in accordance with techniques described here. User interface 310 may be programmed using the same DOM for the web application described with respect to FIG. 3A, with modifications to the view of the user interface 310. Such modification to the view may be done without notifying or modifying the web page associated with the web application, as described above with respect to FIGS. 1-2.

As shown in FIG. 3B, user interface 310 may still include text element 430, and adview element 420, which may now show a different set of text from that depicted in FIG. 3A, such as “Shampoo for $4”.

In some implementations, if multiple adview elements that are associated with the same ad network are opened by the web application, the adview elements may share the same process and isolation storage. For example, turning back to FIG. 2, if multiple adview elements are associated with the same ad network are opened by the web app 201, then the adview elements may share the same process 206 and isolation storage 226, as shown in FIG. 2.

To establish an adview element, a web app may, for example, add a permission to a manifest file, such as an “adview” permission to a “manifest.json” file. The web app includes an “adview” element inside one of its windows. For example, the web app developer may include the adview element by including in “window.html” the following code:

<adview

ad-network=“admob”

publisher-data=“<json string>”/>

An ad_view.js shim (i.e., library) may be injected in the page because of the “adview” manifest permission. The ad_view.js shim may handle the creation of the adview shadow element, as well as an “adview” specific browser-plugin internally. In this example, an adview “ad-network” attribute is internally set to an “admob” URL, which may be defined in a whitelist of allowable advertising networks, for example. In other examples, blacklists of advertising networks may be used.

In some examples, an ad network bootloader script is injected alongside the ad_view.js. The ad network bootloader script may contain code to exchange messages with the embedded ad network software development kit. The ad network bootloader script may expose events related to ads that the publisher can override, such as what happens when an advertisement is displayed or clicked. The ad network bootloader script may also interact with the adview element to control the appearance of the displayed advertisement.

Another software development kit may contain code to display an advertisement. When an add needs to be displayed, the software development kit may send events to the embedding web app, so the ad publisher can override or listen to the ad network behavior. The software development kit may build a URL to serve the ad, using a “getAdvertisingSupportInfo” API to retrieve the advertising identifier (and “isTrackingEnabled” flag). The software development kit may create an iframe pointing to the ad URL. The software development kit may send messages to the bootloader to control the ad appearance (e.g., whether the ad is full screen).

The set of events exposed from the “adview” element does not expose URL and content information. The web app can not inject or execute arbitrary JavaScript inside the adview element.

The top level adview frame can open “iframe” pointing to any URL. This is because ad content may be displayed in an iframe inside the adview and could be served from non-restricted URLs.

The adview DOM sub-tree is not be visible or accessible from the web app. For example, because ad content URLs may contain the advertising identifier, a web app does not have access to sub-iframe elements.

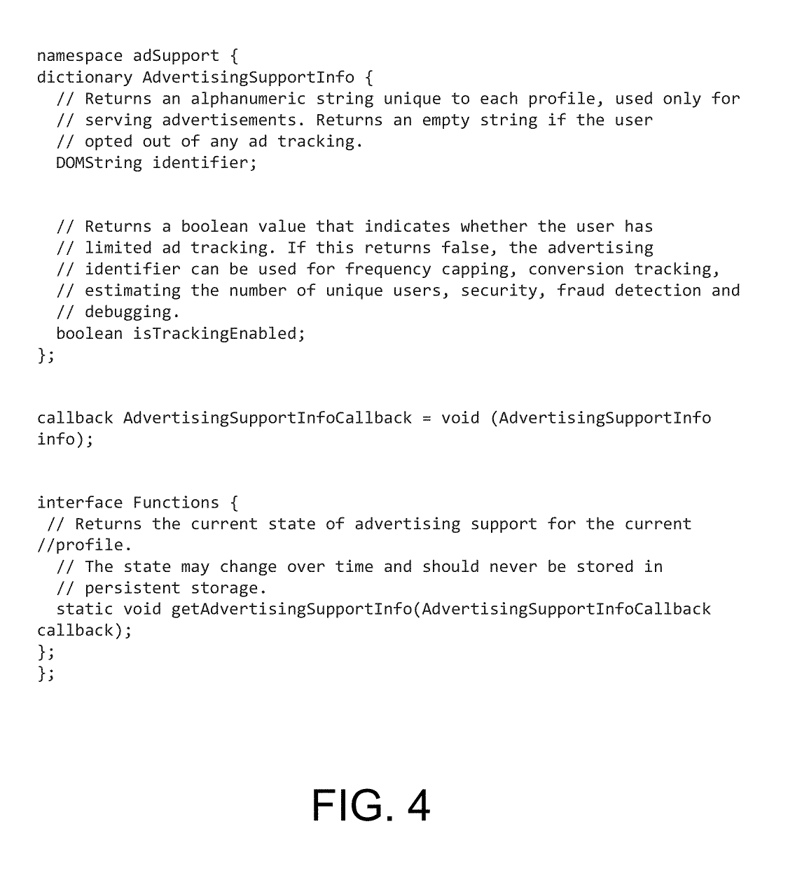

FIG. 4 includes examples of code for the application programming interface (API) that may be used by the web application of FIGS. 3A and 3B. The API may only be available to code (e.g., JavaScript code) running inside an “adview” element such as the adview element 320 shown in FIGS. 3A and 3B. The API returns an alphanumeric string unique to each user profile, which may be used only for serving advertisements. The returned advertising identifier may be unique per user profile and per advertising network of the running adview element. A user may opt out (e.g., via a user interface such as from settings menu of the web application) of any ad tracking, and in such a case, the API may return an empty string. In some cases, a user may opt for limited ad tracking (for example via a user interface).

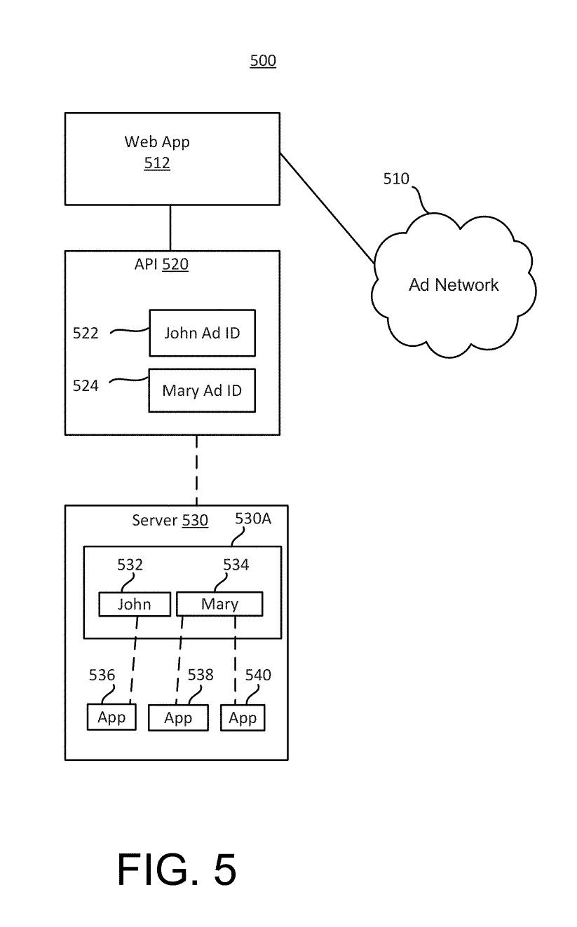

FIG. 5 is a block diagram of a system that may be used to implement the techniques described here. As shown in FIG. 5, the system may include at least one ad network 510. The ad network 510 may be one of multiple ad networks that are whitelisted by a provider of a web application, by a digital marketplace, or by a browser supplier, for example. A web application 512 may communicate with the ad network 510.

The system includes an API 520, which may include elements such as described above with respect to FIG. 4. As discussed above, the API 520 may only be available to code (e.g., JavaScript code) running inside an “adview” element such as the adview element 320 shown in FIGS. 3A and 3B. The API 520 may expose one or more user advertising identifiers, such as John Ad ID 522 or Mary Ad ID 524. The API may expose the user advertising identifiers only to the adview element of the web application 512, and the adview element may use the advertising identifiers to provide specific advertisements, which may be targeted to the user, via the ad network 510.

A server 530 may include a data store 530A including user profiles, such as John 532 and Mary 534. The user profiles may each be associated with one or more installed web applications, such as App 536, App 538, or App 540. The installed web applications, however, cannot access the advertising identifiers (e.g., John Ad ID 522 or Mary Ad ID 524).

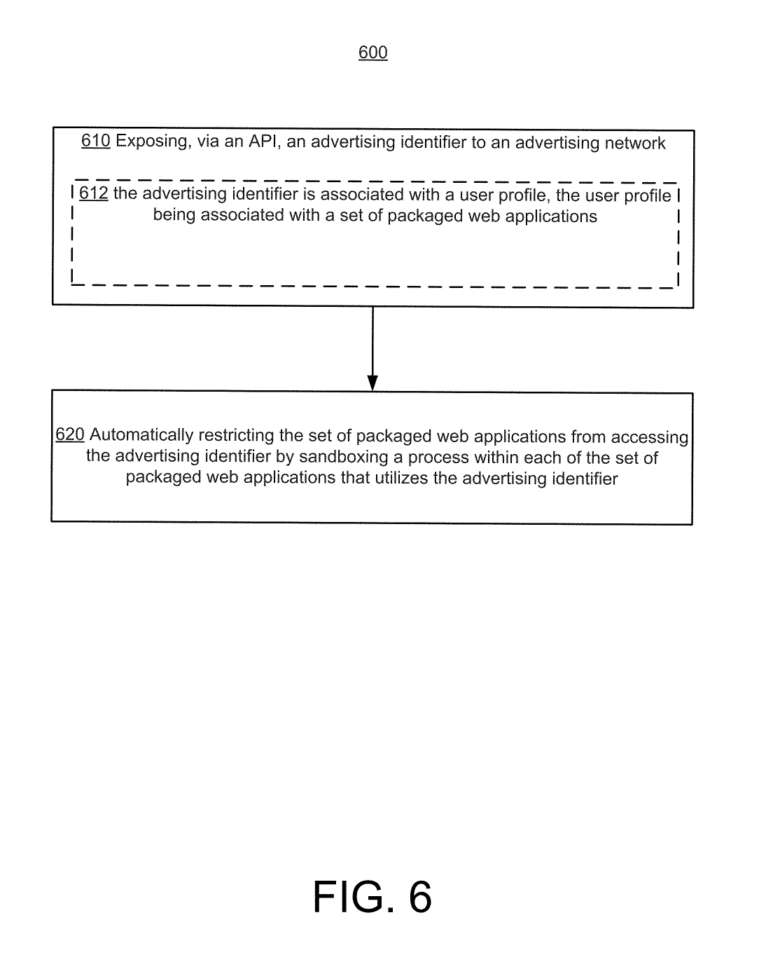

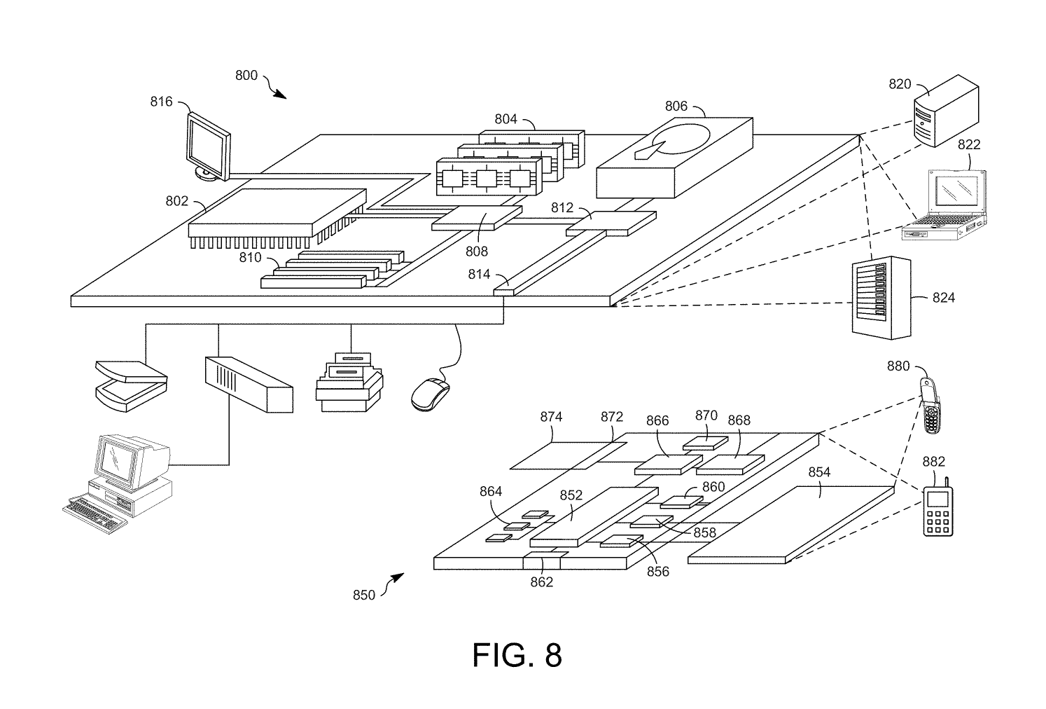

FIG. 6 is a flow diagram illustrating example operations of the system of FIGS. 1-5. The process of FIG. 6 may be performed at least in part by a processor of a computing device. Examples of processors and computing devices that may be used to execute web applications are described in more detail below with respect to FIG. 8.

As shown in FIG. 6, the process 600 may include exposing, via an API, an advertising identifier to an advertising network (610). The advertising identifier may be associated with a user profile, the user profile being associated with a set of packaged web applications associated with the user profile (612). The process may include automatically restricting the set of packaged web applications from accessing the advertising identifier by sandboxing a process within each of the set of packaged web applications that utilizes the advertising identifier (620). For example, as discussed above with respect to FIGS. 3A-4, only an adview element, and not the rest of a web application, may access an advertising user identifier.

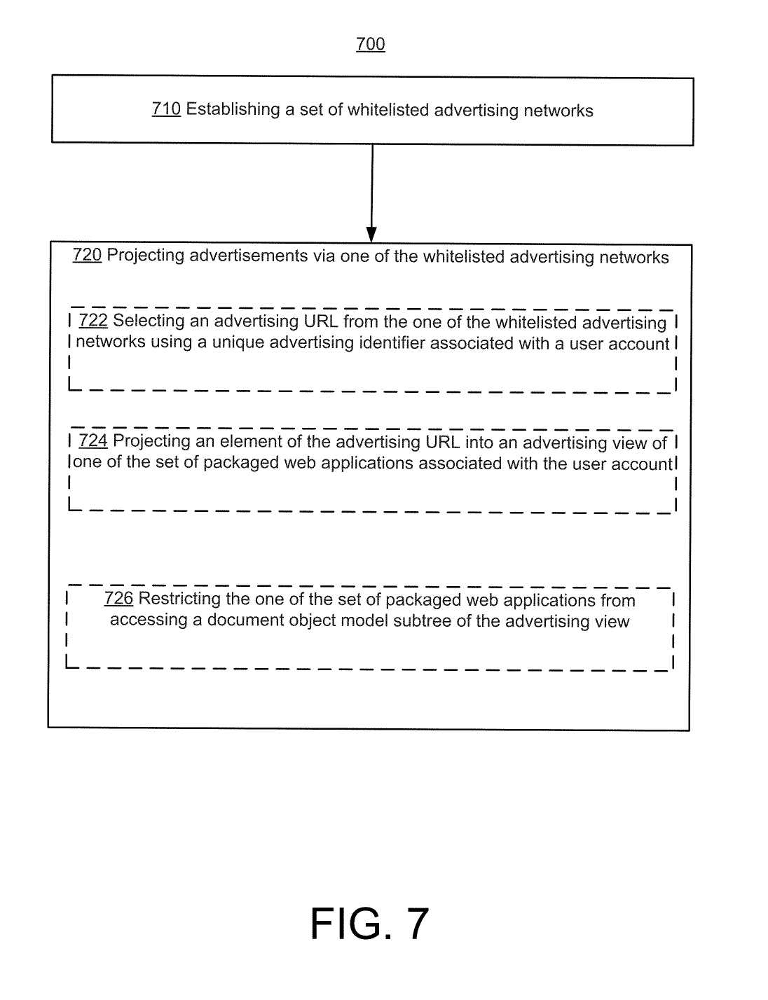

FIG. 7 is another flow diagram illustrating example operations of the system of FIGS. 1-5. The process of FIG. 7 may be performed at least in part by a processor of a computing device. As shown in FIG. 7, a process 700 may include establishing a set of whitelisted advertising networks (710). Such a set may include one or more advertising networks that are specified via an API, for example, by a provider of one of the set of packaged web applications, by a digital marketplace, or by a browser supplier.

The process includes projecting advertisements via one of the whitelisted advertising networks (720). This may include, for example, selecting an advertising URL from the one of the whitelisted advertising networks using a unique advertising identifier associated with a user account (722). Projecting advertisements may also include projecting an element of the advertising URL into an advertising view of one of the set of packaged web applications associated with the user account (724). This may also include restricting the one of the set of packaged web applications from accessing a document object model subtree of the advertising view (726), for example as discussed above with respect to FIG. 3A.

FIG. 8 is a block diagram showing example or representative computing devices and associated elements that may be used to implement systems and methods in accordance with FIGS. 1-7. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, which may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a BLUETOOTH, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made to the implementations described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method comprising
exposing, via an application programming interface, an advertising identifier to an online advertising network executing by at least one microprocessor of a computing device, wherein the advertising identifier is associated with a user profile and is associated with a set of packaged web applications associated with the user profile;
automatically restricting the set of packaged web applications from accessing the advertising identifier by sandboxing a process within each of the set of packaged web applications that utilizes the advertising identifier; and
in response to multiple user interface elements being associated with the online advertising network, providing that the multiple user interface elements share a common process and a common isolation storage.

2. The method of claim 1, wherein the automatically restricting includes preventing the set of packaged web applications from viewing a document object model sub-tree associated with the process.

3. The method of claim 1, further comprising:
displaying advertising content in a frame of a user interface associated with the process.

4. The method of claim 3, wherein the advertising content is pulled from an HTML document.

5. The method of claim 4, wherein the HTML document is associated with the online advertising network.

6. The method of claim 1, further comprising:
providing, via a user interface, an option for a user associated with user profile to reset the advertising identifier.

7. The method of claim 1, further comprising:
providing, via a user interface, an option for a user associated with user profile to limit advertising tracking.

8. The method of claim 1, wherein the online advertising network is one of a set of whitelisted advertising networks.

9. The method of claim 8, wherein the set of whitelisted advertising networks are specified by a provider of one of the set of packaged web applications, by a digital marketplace, or by a browser supplier.

10. The method of claim 1, wherein the online advertising network is specified by a developer of one of the set of packaged web applications.

11. The method of claim 1, wherein the online advertising network is exposed via the application programming interface.

12. The method of claim 1, wherein the online advertising network is identified via a manifest file of one of the set of packaged web applications.

13. The method of claim 1, wherein the advertising identifier is unique for both the user profile and for the online advertising network.

14. A method comprising:
projecting, using a microprocessor of a computing device, advertisements via an online advertising network, including:
selecting an advertising URL from the online advertising network, using a unique advertising identifier associated with a user account;
projecting an element of the advertising URL into an advertising view of a web application associated with the user account; and
restricting the web application from accessing a document object model subtree of the advertising view.

15. The method of claim 14, wherein the document object model subtree of the advertising view is hosted by an element in the document model tree of a web page associated with the web application.

16. The method of claim 14, further comprising:
establishing a set of whitelisted advertising networks; and
selecting the online advertising network from the set of whitelisted advertising networks.

17. The method of claim 16, wherein establishing the set of whitelisted advertising networks includes receiving a list of the set of whitelisted advertising networks via an application programming interface.

18. The method of claim 17, wherein the list is specified by a provider of the web application, by a digital marketplace, or by a browser supplier.

19. The method of claim 17, further comprising:
receiving a selection of the one of the whitelisted advertising networks from a provider of the web application.

20. The method of claim 16, wherein the unique advertising identifier is unique for both the user account and for the advertising network.

21. A system comprising:
an application programming interface;
a memory having stored therein an advertising identifier for an online advertising network, a user profile, and a packaged web application associated with the user profile; and
a processor operably coupled to the memory and configured to execute code to:
expose, via the application programming interface, the advertising identifier to the online advertising network, wherein the advertising identifier is associated with the user profile and is associated with the packaged web application associated with the user profile;
automatically restrict the packaged web application from accessing the advertising identifier by sandboxing a process within the packaged web application that utilizes the advertising identifier; and
in response to multiple user interface elements being associated with the online advertising network, providing that the multiple user interface elements share a common process and a common isolation storage.

22. The system of claim 21, wherein the online advertising network is identified via a manifest file of the packaged web application.

23. The system of claim 21, wherein the advertising identifier is unique for both the user profile and for the online advertising network.

24. The system of claim 21, wherein the processor is further configured to execute the code to:
display advertising content in a frame of a user interface associated with the process.

25. A non-transitory computer readable medium containing instructions that when executed cause a computing device to:
expose, via an application programming interface, an advertising identifier to an online advertising network, wherein the advertising identifier is associated with a user profile and is associated with a packaged web application associated with the user profile;
automatically restrict the packaged web application from accessing the advertising identifier by sandboxing a process within the packaged web application that utilizes the advertising identifier; and
in response to multiple user interface elements being associated with the online advertising network, providing that the multiple user interface elements share a common process and a common isolation storage.

26. The non-transitory computer readable medium of claim 25, wherein the online advertising network is identified via a manifest file of the packaged web application.

27. The non-transitory computer readable medium of claim 25, wherein the advertising identifier is unique for both the user profile and for the online advertising network.

28. The non-transitory computer readable medium of claim 25, wherein the instructions further cause the computing device to:
display advertising content in a frame of a user interface associated with the process.
